(19) United States
(12) Patent Application Publication
(10) Pub. No.: US 2024/0412897 A1
(43) Pub. Date: Dec. 12, 2024

(54) A COMPOSITE CABLE AND METHOD OF MANUFACTURE

(71) Applicant: AMNACK LIMITED, Doncaster (GB)

(72) Inventor: Aaron Walstow, Doncaster (GB)

(21) Appl. No.: 18/697,292

(22) PCT Filed: Sep. 26, 2022
(86) PCT No.: PCT/GB2022/052427

§ 371 Date: Mar. 29, 2024

(30) Foreign Application Priority Data
Sep. 29, 2021 (GB) 2113936.5

(51) Int. Cl. H01B 11/10; C08F 14/06; C08K 5/12; H01B 3/44; H01B 7/24; H01B 13/00; H01B 13/02

(52) U.S. Cl. CPC H01B 11/1033; C08F 14/06; C08K 5/12; H01B 3/443; H01B 7/24; H01B 11/1041; H01B 13/0003; H01B 13/0207

(57) ABSTRACT

A composite cable comprising at least one data cable and at least one electric power core, with the at least one data cable and at least one electric power core insulated to the same nominal voltage rating.

### TECHNICAL FIELD OF THE INVENTION

The present invention relates generally to the field of electrical and data cables. In particular, but not exclusively, the invention concerns a composite cable including at least two cores, at least one of which is a data cable and at least one of which is an electric power core.

### BACKGROUND TO THE INVENTION

Running data and power in a single cable has always been a concern for many electricians, as the segregation of power (band 2) and data (band 1) has been a well understood electrical principle.

British Standard BS7671—Requirements for Electrical Installations requires that Voltage Band 1 (extra low voltage, for example data cables) and Voltage Band 2 (power cores such as 230V) should not be run together. Specifically, British Standard BS7671 states:

Proximity of electrical services (extract form 528.1)—‘Except where one of the following methods is adopted, neither a Band I nor a Band II circuit shall be contained in the same wiring system as a circuit of nominal voltage exceeding that of low voltage, and a Band I circuit shall not be contained in the same wiring system as a Band II circuit . . . ’.

Proximity of communications cables (extract from 528.2)—‘Special considerations of electrical interference, both electromagnetic and electrostatic, may apply to telecommunications circuits, data transfer circuits and the like’.

Therefore, segregation of Band 1 and Band 2 cores is required by the wiring installation standards in order to allow the necessary proximity of electrical services, and the necessary proximity of communications cables.

This creates issues when both Band 1 and Band 2 cables are required for a project. For example, the charging of electric vehicles requires Band 1 and Band 2 cables but due to the segregation required, these are normally run separately.

Embodiments of the invention seek to at least partially overcome or ameliorate any one or more of the abovementioned disadvantages or provide the consumer with a useful or commercial choice.

### SUMMARY OF THE INVENTION

According to a first aspect of the invention there is provided a composite cable comprising at least one data cable and at least one electric power core, with the at least one data cable and at least one electric power core insulated to the same nominal voltage rating.

Providing the at least one data cable and at least one electric power core insulated to the same nominal voltage rating allows a composite cable to be formed containing the at least one data cable and at least one electric power core.

According to a second aspect of the invention there is provided a composite cable comprising at least one data cable and at least one electric power core, with the at least one data cable electrically shielded within the composite cable.

According to a third aspect of the invention there is provided a composite cable comprising at least one data cable and at least one electric power core, and a dummy core within the composite cable to space the data cable and at least one electric power core.

In the present description, use of the term ‘cable’ is also intended to cover a cable with more than one internal core component, namely at least one data cable and at least one electric power core provided inside the same outer sheath. Use of the phrase ‘electric power core’ in intended to cover a core that is used as or as a part of an electrical power supply system, whether the electric power core is live, neutral or earth.

The at least one data cable is preferably super screened to minimise or avoid electronic interference. A super screen may include one or more braided screens and one or more metal foil screens. Such a super screen may be used to provide more complete electrical and magnetic protection. A super screen can limit cable flexibility in some circumstances and therefore generally needs to be balanced by an optimum lay length and/or twist angle.

Each core may be provided with separate polymeric insulation material with dielectric strength to withstand high voltage testing at 2500V. Each core may have polymeric insulation. In one form, the insulation may have a thickness of approximately 0.3 mm.

The cores may be protected by a polymeric bedding material. The polymeric bedding material may be provided about an outer side of the respective cores and sandwich the cores relative to one another. The polymeric bedding material will normally be provided within an outer jacket or sheath of the composite cable.

In an embodiment, the data cable may be rated for a voltage of 600V, at a frequency of up to 1600 Hz.

A screen material of tinned copper may be used. Tinned copper may be used for a 2-core data cable. Preferably, the screen will have >80% braid coverage.

A screen material of aluminium foil may be used. Aluminium foil may be used particularly for a 4 pair data cable. Preferably, a foil screen will have a higher coverage, up to 100%.

In one form, the composite cable is based on a single-phase supply which may require 3 electrical power cores to achieve an earth, neutral and live connection.

This may not be suitable for all types of connection, however. For example, many commercial electric vehicle charge units use a three-phase 400V supply. When a cable of this nature includes a data cable as well, there can be five cores within a single cable. The twisting process on larger 5-core cables (to form the cable) is much more severe and applies a lot more pressure (tension) on the data cable. This can affect the integrity of the data cable.

A dummy core may be used to alleviate this and preserve the integrity of the data cable. A dummy core may be used to assist with forming a composite cable of any type, with any number of cores, but is particularly useful for forming a larger cable with five or more cores. Surprisingly, without the dummy core, the pressure applied on the data cable exceeded levels of acceptance and began to affect the integrity of the data cable. The inclusion of a dummy core allows the cable to be twisted (formed) maintaining the integrity of the data cable.

The dummy core may be provided in a central position relative to the cores. The cores are usually twisted about an exterior surface of the dummy core. The dummy core may be provided centrally within the cable and allows a concentric spiral of the cores to formed about the dummy core. The provision of the dummy core has been found to maintain the lay length of the data cable and/or the other cores so that the lay lengths are not altered/damaged during the twisting process.

The dummy core may only be used in 3 phase forms of the composite cable. Although any shape may be used, in one simple form, the dummy core may be circular.

The dummy core is preferably more flexible than the at least one power core provided.

The size of the dummy core is usually calculated relative to the composite cable type and/or outer cable diameter and/or composite cable cross sectional area. For example, a 6.0 mm² composite cable may require a 4.5 mm diameter dummy core. A 10.0 mm² composite cable may requires 5.5 mm diameter dummy core.

The dummy core may be combined with a tape that is applied around the assembled cores (once twisted together and prior to the application of the outer jacket or sheath. In one form, a polyester tape may be used.

In use, the dummy core is fed into the twisting machine used to form the composite cable, and the cores are then formed (twisted) around the dummy cable. A taping machine may then be used to apply a tape to hold all of the cores in place so that the assembled core does then not alter configuration at future stages in the formation process. This again assists with the prevention of any movement of the data cable which could affect the lay-length of the data cable and/or the power cores (which is important to minimising or avoiding interference and/or data degradation).

According to a fourth aspect of the invention there is provided a composition comprising polyvinylchloride with a K-value of between 35 and 80, di (2-propylheptyl) phthalate, at least one filler and a stabiliser.

In an embodiment, the at least one filler may comprise at least one polyvinylchloride filler.

The composition may be utilised as a bedding material for providing about the assembled cores of the composite cable, within the outer jacket or sheath or in circumstances where an outer jacket or sheath is not provided. However, given its properties, the composition may have other uses.

The composition has a high abrasion resistance that protects the composite cable from installation practices expected (such as difficult cable routes, and the cable being pulled along concrete floors and building work).

The composition has a high impact resistance that protects the composite cable from impacts, such as impacts from vehicle doors in tight parking situations.

The composition has good thermal stability to achieve operating temperatures of 90° C. that allow for higher current carrying capacities. For example, utilising the composition as a bedding material within a composite cable, a 4.0 mm² conductor could achieve 7.2 kW (which is a popular current carrying capacity of electric vehicle charger).

The composition has good UV stability which allows long term operation in sunlight for exterior use.

Standard grades of bedding material available as specified in the British Standards for such requirements, were trialled against the composition and, a composite cable including the composition used as bedding material had decreased stiffness compared to the same cable using standard bedding grades, which proved more difficult to install and route.

The K-value is a characteristic of the polyvinylchloride (PVC) resin which describes the length of the polymer molecules. It is usually a measure of the molecular weight of PVC based on measurements of viscosity of a PVC solution. It ranges usually between 35 and 80. In an embodiment, a K-value of approximately 70 has been found to be optimal.

Using PVC with a K-value of 70, the amount of the respective components may be as follows (on a weight basis):

| Material | Amount |
|---|---|
| PVC resin | 200-400, preferably approx. 300 |
| DPHP | 200-400, preferably approx. 250 |
| PVC Filler | 200-600, preferably approx. 400 |
| Stabiliser | 10-20, preferably approx. 15 |

In an embodiment, a particularly preferred formulation for the composite material is 319.1 parts of polyvinylchloride with a K-value of 70, 257 parts of di (2-propylheptyl) phthalate, 408.1 parts of PVC filler and 15.8 parts of stabiliser.

According to a fifth aspect of the invention there is provided a composite cable comprising at least one data cable and at least one electric power core, and a bedding outside the at least two operating cores.

The bedding may be provided within the composite cable outside the at least two operating cores and within at least one outer jacket of the composite cable.

The bedding may be applied around the cores and/or at least partially between one or more of the operating cores. The bedding may act as a filler between the outer jacket and the operating cores. The bedding may act as a filler between armour, for example steel wire armour, and the operating cores (depending on whether the cable has armour or not).

The composition of the fourth aspect may be used as the bedding of the fifth aspect.

According to a sixth aspect of the invention there is provided a method of forming a composite cable comprising at least one data cable and at least one electric power core, the method comprising the steps of providing pay-off equipment to feed the data cable at a low tension and twisting the data cable and at least one electric power core to form a circular cable.

The usual process that is used to twist cores together to form a multi-core cable is unsuitable for use with a data cable as the elements within the data cable can be damaged by excessive longitudinal tension.

In an embodiment, a machine usually used to apply an armour to a cable can be used to twist (form) the composite cable. Pay-off equipment and feed braking arrangements can be used to control the supply of the operating cores to such a machine to lower the tension applied to the at least one data cable in particular, to achieve a twist assembly that is gentle enough to not compromise the at least one data cable′ performance with regards insertion loss, impedance, return loss, cross talk and the like.

The running parameters of the machine differ for each composite cable to account for different composite cable characteristics.

Once an assembled (twisted) composite cable has been formed, bedding material and/or an outer jacket or sleeve can be applied.

An example of running parameters for a product at the core twisting/assembly stage is as follows: 3×6.0 mm² with 2-core data cable has a lay length of 191 mm and a twist angle of 10°. The tension on cores is maintained at or around 12 kg. A taping unit applies tape ate 325 RPM. The composite cable is formed at a linear speed of approximately 15 m/min. A track conveyor may be used to helps pull the cable along the line. Use of a track conveyor may reduce the tension being applied by the drums (from which the cable components are fed) on the machine. A traction pressure of 2 bar may be used to ensure enough tension is removed from the line, without too much pressure being applied on the cable that could then damage the structure of the cable (the data cable in particular).

The composite cable may be shielded/screen or unscreened.

Any one or more of the operating cores may be shielded/screened. The at least one data cable will typically be shielded/screened.

Any type of shielding may be used. Different types of shielding may be used for different purposes and/or four different operating cores. Electrical screens typically come in the form of foiled tapes, spiral-wound (lapped) wires or braided screens.

Any material may be used. Copper is a particularly preferred material given its physical characteristics but other material such as aluminium may be used. Nickel plated wire or foil may be used if higher operating temperatures are required.

Foil screens are preferably the most effective at high frequencies as a foil screen can provide up to 100% coverage. However, foil screens are generally quite thin and brittle and therefore, they may not be particularly useful for low-frequency and/or dynamic use. In addition, for screens normally require a drain wire for termination into the connector. The drain wire is normally best placed in the interstices of the composite cable in order to help the composite cable retain its substantially circular cross section. If placed elsewhere, drain wire will usually create an inconsistency in shape, which may then require a pressure extruded sheath in order to keep the composite cable substantially circular. A drain wire is not always necessary if the foil screen is complied with a braided screen. Plated copper wire is normally used for lapped shielding.

A spiral wound (lapped) wire may be provided as a single layer of wire wound around the composite cable. A lapped screen may not have the strength and robustness of a braided screen. A lapped screen is normally held in place using tape. A lapped screen may be the weakest of the screening options from an electrical point of view as it has neither the coverage of the foil screen for higher frequency nor the thickness of a braided screen for low frequencies. Lapped wire screens are particularly useful for flexibility and for retaining improved flexibility over their service life.

Braided screens typically offer long-term flexibility and good shielding properties at lower frequencies. Braided screens may be formed from plated copper wire. Braided screens can be manufactured to offer different levels of coverage. The minimum level of coverage will preferably be at least 70% with at least 85% preferred and as EMC shielding becomes more important, braided screens having coverage of above 90% could be used. If high levels of coverage are required, multiple screens can be used.

In an embodiment, a combination of foil and braid may be used to provide the best screening over a wide range of frequencies.

Any one or more of the cores and/or the composite cable may be super screened. Super screening may be accomplished using one or more braided screens and one or more foil screens together to provide more complete electrical and magnetic protection. Super screening may adversely affect cable flexibility.

In an embodiment, the composite cable may be screened about the assembled core, inside an outer jacket or sleeve.

In an embodiment each operating core may be screened.

In an embodiment, each pair within a data cable can be screened.

A combination of screening may be provided wherein each pair within a data cable is screened, then the data cable is screened.

The composite cable may be armoured or not. If the composite cable is armoured, a metal armour may be provided. A wire braid armour may be used however armour made from a plastic material such as an aramid braid may also be used.

During formation of the cable, the cable may be twisted in either direction, namely either left hand twisted, or right hand twisted.

Each operating core may be insulated. Any material may be used to insulate each operating core. A preferred material is XLPE although other materials may be used. Any insulation material would preferably have an operating temperature of 90° Celsius or higher.

The composite cable may be provided in a single-phase embodiment. In a single-phase embodiment, three power cores may be provided, namely an earth core, live core and a neutral core together with the data cable.

The composite cable may be provided in a three-phase embodiment. In a three-phase embodiment, five power cores may be provided, namely an earth core, neutral core and three live cores together with the data cable.

As mentioned above, a dummy core may be provided in any composite cable.

Bedding may be provided about the assembled cores and/or at least partially between any one or more of the operating cores. The bedding may be provided in order to provide the assembled cores with a substantially circular cross section as well as to protect the assembled cores, whilst minimising the loss of flexibility. The bedding may be compressed.

The composite cable may be provided with an outer jacket or sleeve. Although a variety of materials may be used for the outer sleeve, the outer sleeve will normally be a material such as polyvinyl chloride. However, an armoured cable may be provided in which the outer sleeve is armour braid.

As mentioned above, the assembled cores may be taped for better security. Again, although a variety of materials may be used, a polyethylene tape may be provided about the assembled cores.

Chalk may be applied if the assembled cores are not taped.

One or more features of any one or more of the first five aspects may be used in combination.

### DETAILED DESCRIPTION OF THE INVENTION

In order that the invention may be more clearly understood one or more embodiments thereof will now be described, by way of example only, with reference to the accompanying drawings, of which:

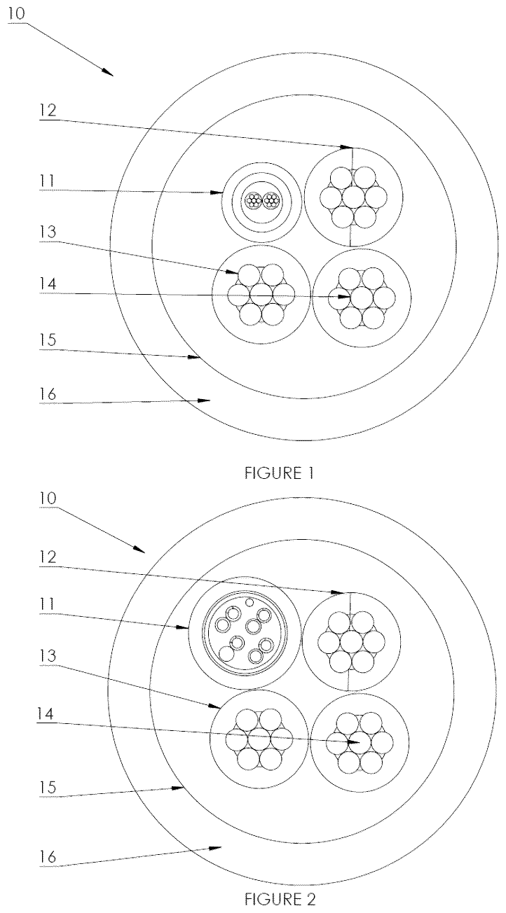

FIG. 1 is a schematic section view of a composite cable of an embodiment with a 2-core twisted data cable and power cores.

FIG. 2 is a schematic section view of a composite cable of an embodiment with a 4-pair data cable and power cores.

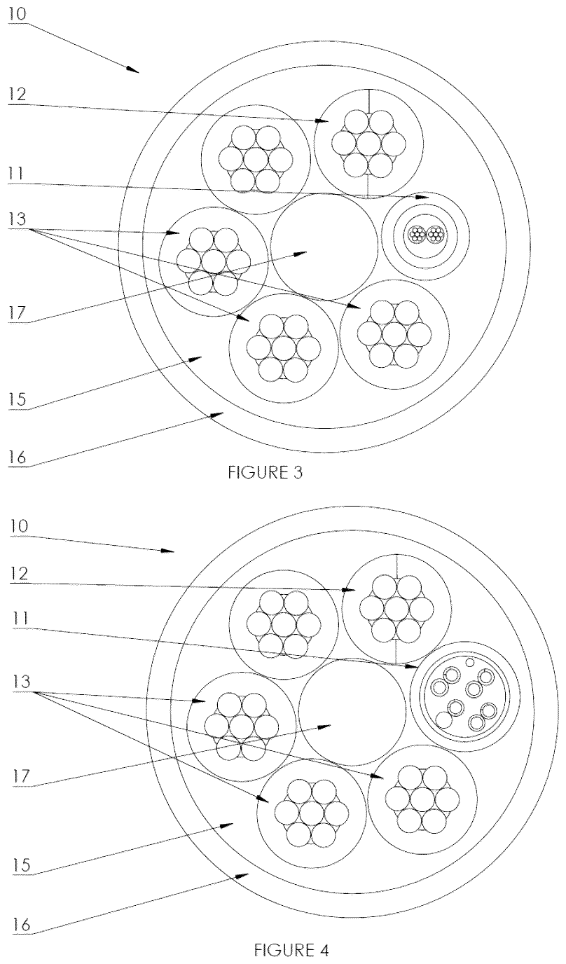

FIG. 3 is a schematic section view of a composite cable of an embodiment with a 2-core twisted data cable and 3-phase power cores.

FIG. 4 is a schematic section view of a composite cable of an embodiment with a 4-pair data cable and 3-phase power cores.

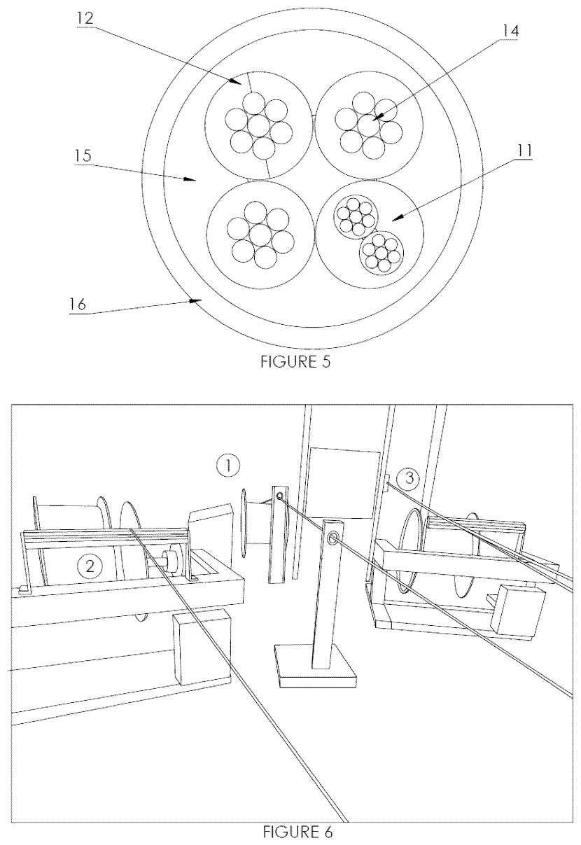

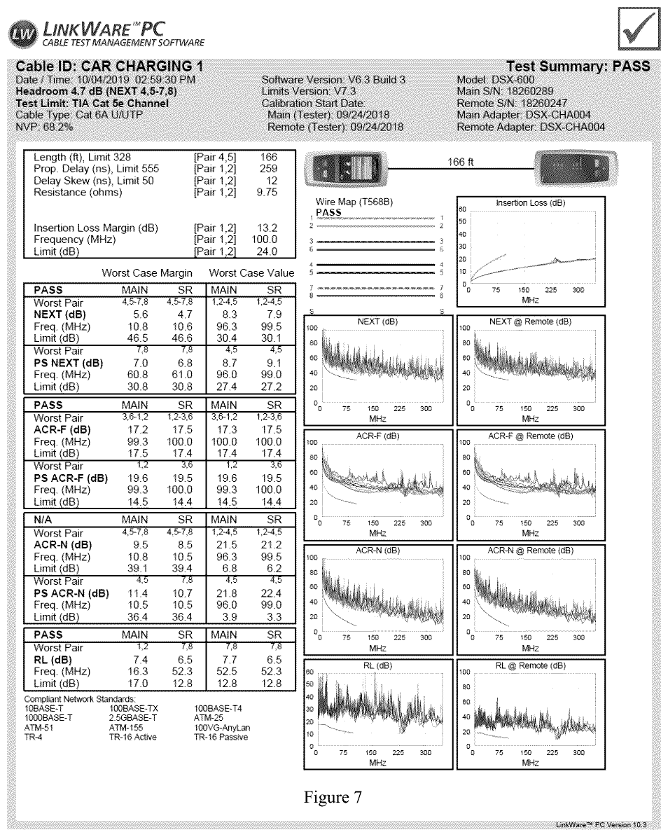

FIG. 5 is a schematic section view of a composite cable of a further embodiment with a 2-core twisted data cable and power cores.

FIG. 6 shows pay-off equipment to a machine used to achieve a twist assembly in the composite cable of an embodiment.

FIG. 7 shows sample test data of a composite cable of an embodiment whilst used to charge an electric vehicle.

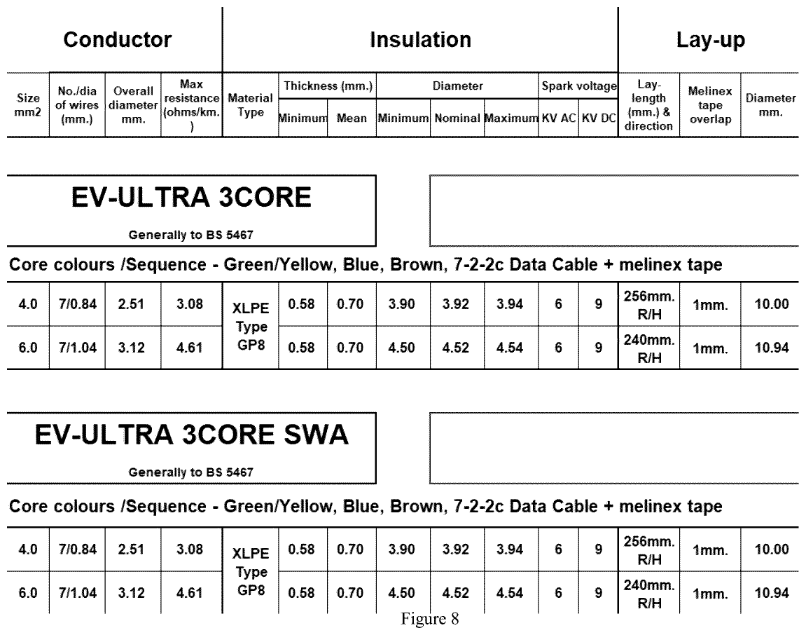

FIG. 8 shows part 1 of a table of parameters of formation of a composite cable of a number of embodiments and parameters relating to their formation.

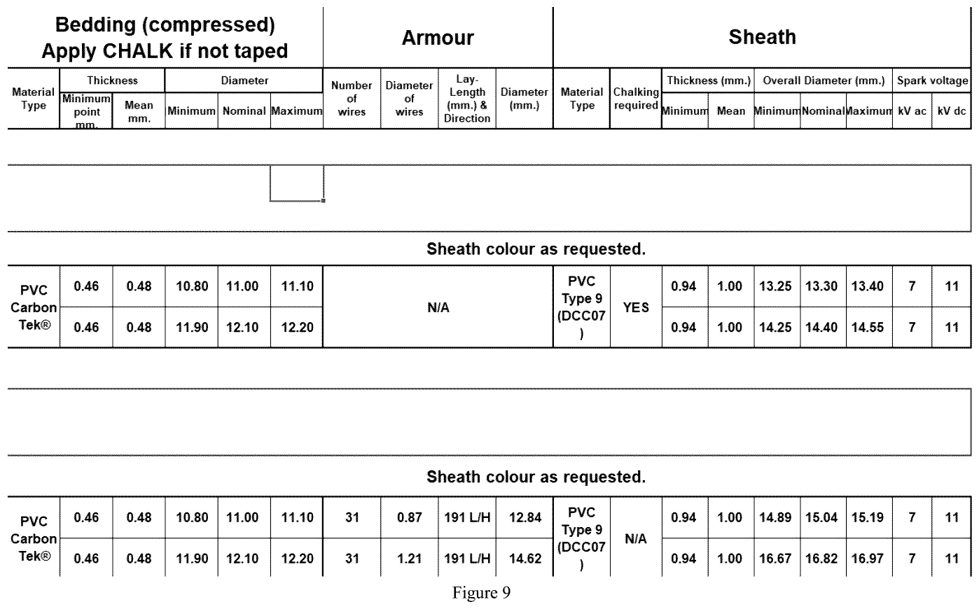

FIG. 9 shows part 2 of the table illustrated in FIG. 8.

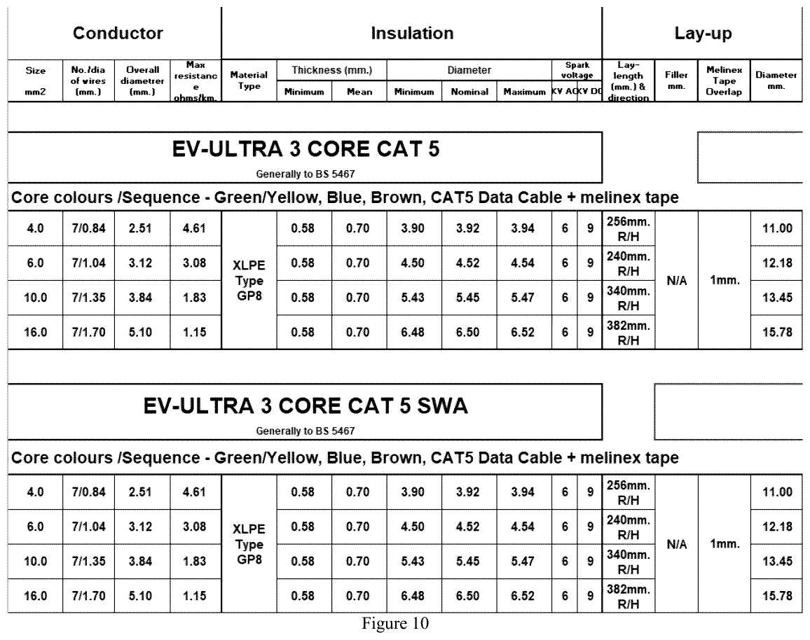

FIG. 10 shows part 1 of a table of parameters of formation of a composite cable of a number of further embodiments and parameters relating to their formation.

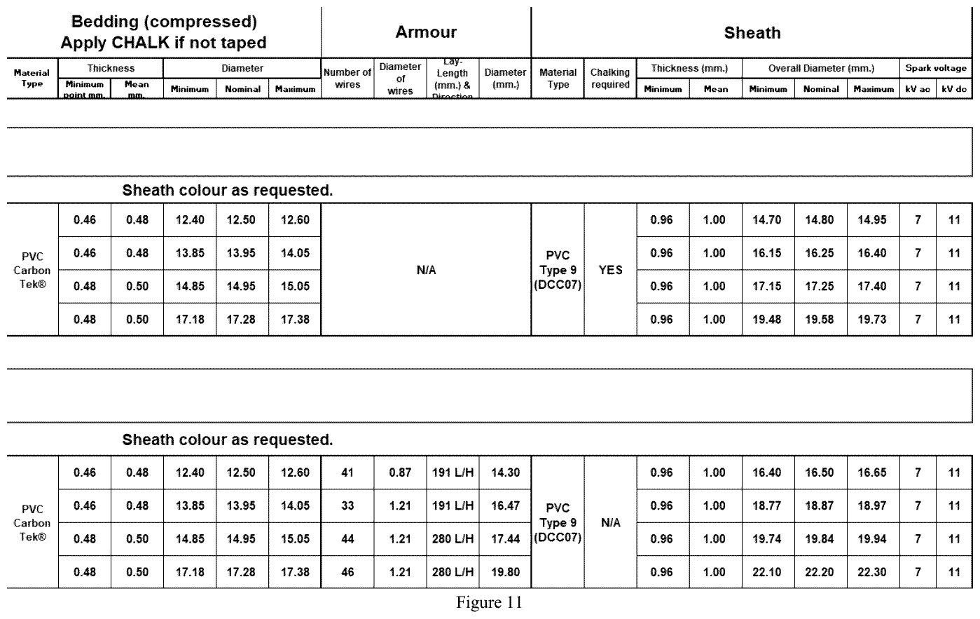

FIG. 11 shows part 2 of the table illustrated in FIG. 10.

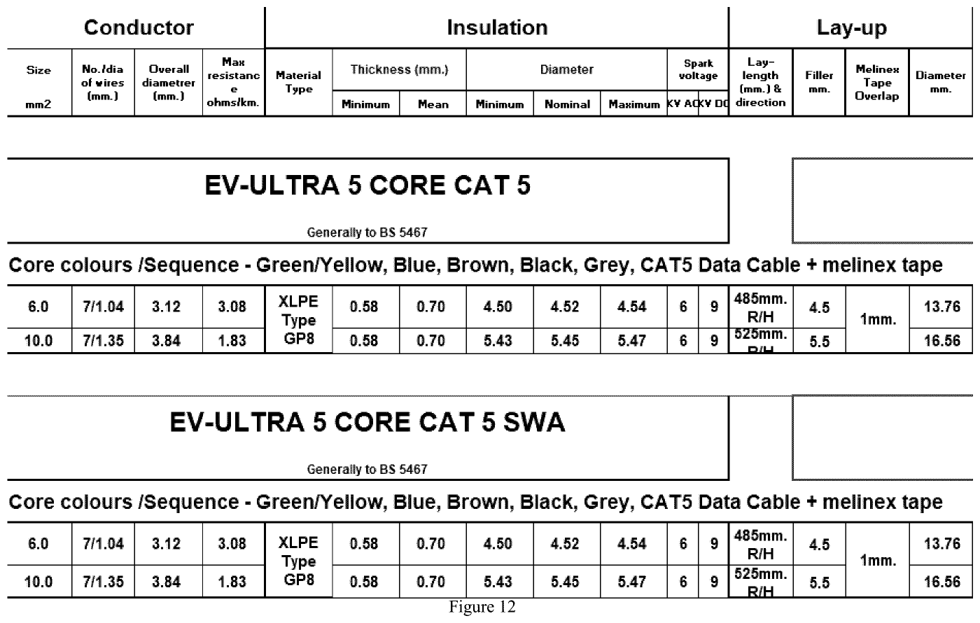

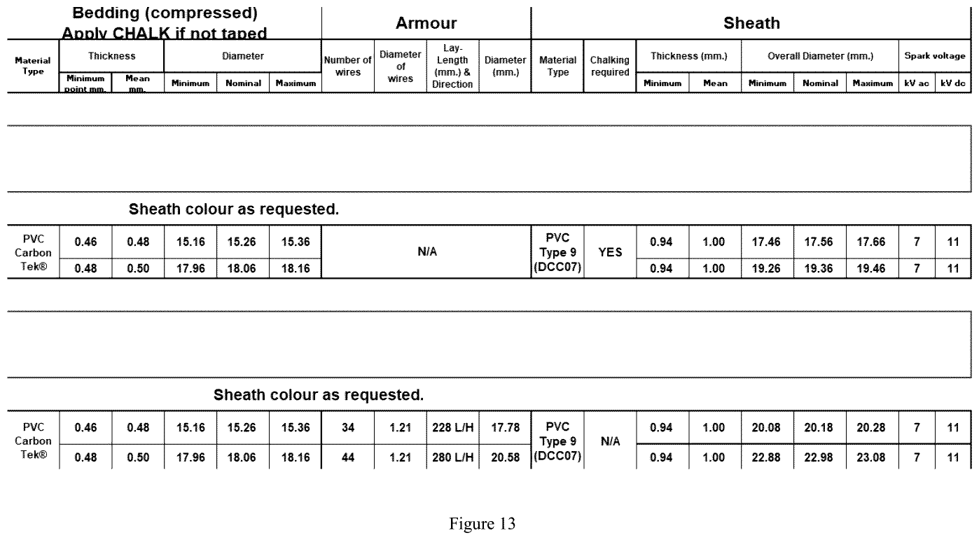

FIG. 12 shows part 1 of a table of parameters of formation of a composite cable of a number of further embodiments and parameters relating to their formation.

FIG. 13 shows part 2 of the table illustrated in FIG. 12.

With reference to the accompanying figures, various configurations of a composite cable 10 is illustrated in FIGS. 1 to 5.

In each case, the composite cable 10 comprises at least two cores, at least one of which is a data cable 11 and at least one electric power core, with the at least one data cable 11 and at least one electric power core insulated to the same nominal voltage rating.

The composite cable 10 may be provided in a single-phase embodiment, examples of which are illustrated in FIGS. 1 and 2. In a single phase embodiment, three power cores are provided, namely an earth core 12, live core 13 and a neutral core 14, together with the data cable 11.

In the embodiment illustrated in FIG. 1, a composite cable 10 with an earth core 12, live core 13 and a neutral core 14 is shown, together with a super screened, 2-core twisted data cable 11.

In this embodiment, the data cable may be rated for a voltage of 600V at a frequency of up to 1600 Hz.

Super screening may be accomplished using one or more braided screens and one or more foil screens together to provide more complete electrical and magnetic protection. A screen material of tinned copper may be used for the 2-core data cable. Preferably, the screen will have >80% braid coverage.

Each core may be provided with separate polymeric insulation material with dielectric strength to withstand high voltage testing at 2500V. Each core may have polymeric insulation. In one form, the insulation may have a thickness of approximately 0.3 mm.

Each of the earth core 12, live core 13 and neutral core 14 of this embodiment is a 6.0 mm2, XLPE insulated core.

As mentioned above, the assembled cores may be taped for better security. Again, although a variety of materials may be used, a polyethylene tape may be provided about the assembled cores. Chalk may be applied if the assembled cores are not taped.

A polymeric bedding material 15 is provided about the assembled cores and/or at least partially between any one or more of the operating cores. The polymeric bedding material may be provided about an outer side of the respective cores and sandwich the cores relative to one another. As illustrated, the polymeric bedding material 15 is provided within the outer jacket or sheath 16 of the composite cable 10.

The bedding material 15 also provides the assembled cores with a substantially circular cross section as well as protecting the assembled cores, whilst minimising the loss of flexibility. The bedding material 15 used may be compressed.

The polymeric bedding material 15 used in the illustrated embodiments is a proprietary formula referred to as CarbonTek in this disclosure. The composition of CarbonTek comprises polyvinylchloride with a K-value of between 35 and 80, di (2-propylheptyl) phthalate, polyvinylchloride filler and a stabiliser.

The CarbonTek bedding material 15 has a high abrasion resistance that protects the composite cable 10 from installation practices expected (such as difficult cable routes, and the cable being pulled along concrete floors and building work).

The CarbonTek bedding material 15 also has a high impact resistance that protects the composite cable from impacts. For example, following the charging cable for electric vehicles example, the CarbonTek bedding material 15 will protect against impacts from vehicle doors in tight parking situations and the like.

The CarbonTek bedding material 15 has good thermal stability to achieve operating temperatures of 90° C. that allow for higher current carrying capacities. For example, utilising the composition as a bedding material within a composite cable, a 4.0 mm² conductor could achieve 7.2 kW (which is a popular current carrying capacity of electric vehicle charger).

The CarbonTek bedding material 15 also has a UV stability which allows long term operation in sunlight for exterior use.

Using PVC with a K-value of 70, the amount of the respective components may be as follows (on a weight basis):

| Material | Amount |
|---|---|
| PVC resin | 200-400, preferably approx. 300 |
| DPHP | 200-400, preferably approx. 250 |
| PVC Filler | 200-600, preferably approx. 400 |
| Stabiliser | 10-20, preferably approx. 15 |

In an embodiment, a particularly preferred formulation for the composite material is 319.1 parts of polyvinylchloride with a K-value of 70, 257 parts of di (2-propylheptyl) phthalate, 408.1 parts of PVC filler and 15.8 parts of stabiliser.

The composite cable is provided with an outer jacket or sleeve 16. Although a variety of materials may be used for the outer sleeve, the outer sleeve will normally be a material such as polyvinyl chloride.

The single-phase composite cable illustrated in FIG. 2 is similar to that shown in FIG. 1 but includes a super screened, 4 twisted pair data cable rather than the 2-core twisted pair data cable shown in FIG. 1.

A screen material including aluminium foil may be used for a 4 pair data cable. Preferably, a foil screen will have a higher coverage, up to 100%.

The composite cable 10 may be provided in a three-phase embodiment, examples of which are illustrated in FIGS. 3 and 4. In a three-phase embodiment, five power cores are provided, namely an earth core 12, neutral core 14 and three live cores 13 together with the data cable 11. A dummy core 17 is provided in both illustrated three phase composite cables.

Many commercial electric vehicle charge units use a three-phase 400V supply. When a cable of this nature includes a data cable as well, there are five cores within a single cable. The twisting process on larger 5 core cables (to form the cable) is much more severe and applies a lot more pressure (tension) on the data cable. This can affect the integrity of the data cable.

The dummy core 17 is used to assist with forming a composite cable of any type, with any number of cores, but is particularly useful for forming a larger cable with five or more cores. Without the dummy core 17, the pressure applied on the data cable 11 during the twisting process, exceeds levels of acceptance and adversely affects the integrity of the data cable 11. The inclusion of a dummy core 17 allows the cable 10 to be twisted (formed) maintaining the integrity of the data cable 11.

The illustrated dummy core 17 has a circular cross-sectional shape and is provided in a central position relative to the cores. The cores are twisted about an exterior surface of the dummy core 17 which allows a concentric spiral of the cores to be formed about the dummy core 17. The dummy core 17 maintains the lay length of the data cable and/or the other cores so that the lay lengths are not altered/damaged during the twisting process.

The dummy core 17 is preferably more flexible than the power cores 12, 13, 14 provided.

The size of the dummy core 17 is usually calculated relative to the composite cable type and/or outer cable diameter and/or composite cable cross sectional area. For example, as shown in FIGS. 7 to 10, a 6.0 mm² composite cable may require a 4.5 mm diameter dummy core. A 10.0 mm² composite cable may require 5.5 mm diameter dummy core.

The dummy core 17 may be combined with the tape that is applied around the assembled cores (once twisted together and prior to the application of the outer jacket or sheath) to maintain the twisted cable together. In one form, a polyester tape is used.

In use, the dummy core 17 is fed into the twisting machine used to form the composite cable 10, and the cores are then formed (twisted) around the dummy core 17. A taping machine may then be used to apply a tape to hold all of the cores in place so that the assembled core does then not alter configuration at future stages in the formation process. This again assists with the prevention of any movement of the data cable 11 which could affect the lay-length of the data cable 11 and/or the power cores 12, 13, 14 (which is important to minimising or avoiding interference and/or data degradation).

Another version of a single-phase composite cable is shown in FIG. 5. In this version, three, 4.0 mm² power cores are used with a 2-core data cable. Polymeric bedding 15 is provided thereabout and a PVC outer jacket or sheath 16 is used.

FIG. 6 shows pay-off equipment used to feed a data cable 11 at a low tension to a machine used to twist the data cable and electric power cores to form a circular composite cable.

The prior art method that is used to twist cores together to form a multi-core cable using a machine known as a ‘buncher’ or a ‘strander’, is unsuitable for use with a data cable 11 as the elements within the data cable 11 can be damaged by excessive longitudinal tension.

In an embodiment, a machine usually used to apply an armour to a cable can be used to twist (form) the composite cable 10. Pay-off equipment and cable feed braking arrangements can be used to control the supply of the operating cores to such a machine to lower the tension applied to the data cable 11 in particular, to achieve a twist assembly that is gentle enough to not compromise the performance of the data cable with regards insertion loss, impedance, return loss, cross talk and the like.

This method is much slower than conventional methods of twisting cores together but allows assembly of a composite cable without degradation of the data cable properties.

The running parameters of the machine differ for each composite cable to account for different composite cable characteristics.

Once an assembled (twisted) composite cable has been formed, the bedding material 15 and/or an outer jacket or sleeve 16 can be applied.

An example of running parameters for a product at the core twisting/assembly stage is as follows: 3×6.0 mm² with 2-core data cable has a lay length of 191 mm and a twist angle of 10°. The tension on cores is maintained at or around 12 kg. A taping unit applies tape ate 325 RPM. The composite cable is formed at a linear speed of approximately 15 m/min. A track conveyor may be used to helps pull the cable along the line. Use of a track conveyor may reduce the tension being applied by the drums (from which the cable components are fed) on the machine. In one embodiment, a traction pressure of 2 bar is used to ensure enough tension is removed from the line, without too much pressure being applied on the cable that could then damage the structure of the cable (the data cable in particular).

During formation of the cable, the cable may be twisted in either direction, namely either left hand twisted, or right hand twisted.

Examples of various cable parameters are shown in FIGS. 7 to 11 including construction aspects such as winding direction, armour, as well as physical parameters such as size of the cables and the sizes of the respective cores.

The one or more embodiments are described above by way of example only. Many variations are possible without departing from the scope of protection afforded by the appended claims.

1. A composite cable comprising at least one data cable and at least one electric power core, with the at least one data cable and at least one electric power core insulated to the same nominal voltage rating.

2. A composite cable as claimed in claim 1 wherein the at least one data cable is super screened using one or more braided screens and one or more metal foil screens to minimise or avoid electronic interference.

3. A composite cable as claimed in claim 1 wherein each core is provided with separate polymeric insulation material with dielectric strength to withstand high voltage testing at 2500V.

4. A composite cable as claimed in claim 1 wherein a polymeric bedding material is provided about an outer side of the respective cores and at least one data cable and sandwich the cores and at least one data cable relative to one another.

5. A composite cable as claimed in claim 1 wherein the at least one data cable is rated for a voltage of 600V at a frequency of up to 1600 Hz.

6. A composite cable comprising at least one data cable and at least one electric power core, with the at least one data cable electrically shielded within the composite cable.

7. A composite cable as claimed in claim 1 wherein an electrical screen is used comprising at least one of foil, spiral-wound (lapped) wire or braided screen.

8. A composite cable as claimed in claim 7 wherein a combination of foil and braided screen.

9. A composite cable as claimed in claim 7 wherein the at least one data cable is screened.

10. A composite cable comprising at least one data cable and at least one electric power core, and a dummy core within the composite cable to space the data cable and at least one electric power core.

11. A composite cable as claimed in claim 1 wherein a circular dummy core is provided in a central position within the composite cable.

12. A composite cable as claimed in claim 11 wherein the at least one data cable and at least one electric power core are twisted about an exterior surface of the dummy core.

13. A composite cable as claimed in claim 11 wherein the dummy core is more flexible than the at least one power core provided.

14. (canceled)

15. A composite cable as claimed in claim 11 wherein a tape is applied around the at least one data cable and at least one electric power core once twisted together.

16. A polymeric composition comprising polyvinylchloride with a K-value of between 35 and 80, di(2-propylheptyl) phthalate, at least one filler and a stabiliser.

17. (canceled)

18. A polymeric composition as claimed in claim 16 wherein the K-value of the polyvinylchloride is approximately 70.

19. A polymeric composition as claimed in claim 16 wherein the polyvinylchloride is provided in 200-400 parts, the di(2-propylheptyl) phthalate is provide in 200-400 parts, the at least one filler is provided in 200-600 parts and the stabiliser is provided in 10-20 parts, on a weight basis.

20. A polymeric composition as claimed in claim 16 wherein utilised as a bedding material for providing about the at least one data cable and at least one electric power core of the composite cable as claimed in any one of claims 1 to 15, once twisted together.

21. A composite cable comprising at least one data cable and at least one electric power core, and a bedding layer comprising a polymeric composition as claimed in claim 15, outside the at least one data cable and at least one electric power core.

22. (canceled)

23. A method of forming a composite cable comprising at least one data cable and at least one electric power core, the method comprising the steps of providing pay-off equipment to feed the data cable at a low tension and twisting the at least one data cable and at least one electric power core to form a circular cable.

24. (canceled)

25. (canceled)

26. (canceled)
